(19) United States
(12) Patent Application Publication
(10) Pub. No.: US 2012/0180380 A1
(43) Pub. Date: Jul. 19, 2012

(54) Bug Catching Apparatus

(76) Inventor: William C. Grant, III, Phoenix, AZ (US)

(21) Appl. No.: 13/350,251

(22) Filed: Jan. 13, 2012

Related U.S. Application Data
(60) Provisional application No. 61/433,315, filed on Jan. 17, 2011.

(51) Int. Cl. A01M 3/04

(52) U.S. Cl. 43/136

(57) ABSTRACT

The invention is a bug catching apparatus for catching and disposing of bugs. The invention catches bugs using a deformable wall, sticky on one side, and a relatively ridged perimeter to keep the sticky side from inadvertently sticking to a surface but still allowing the deformable wall to flex and catch the bug on the sticky surface when the bug is within the perimeter. The sticky part of the apparatus is designed to be disposable, so a user can catch and dispose of bugs without ever having to touch the bug. The invention also minimizes the mess associated with killing bugs and minimizes the mess of inadvertently getting a sticky bug catcher stuck to a wall or a countertop.

### CROSS-REFERENCE TO RELATED APPLICATION

The present application claims priority to co-pending U.S. provisional patent application entitled “Bug Catching Apparatus,” having Ser. No. 61/433,315, filed on Jan. 17, 2010, which is entirely incorporated herein by reference.

### SUMMARY OF THE INVENTION

The invention, a bug catching device, comprises a structure for trapping or catching bugs and disposing of said bugs.

The apparatus 1, a bug catcher, minimizes the likelihood both of human contact with the bug or pest and the mess associated with killing bugs. The bug catcher generally comprises a relatively thin deformable wall 10 having a first side 101 and a second side 102 and having an adhesive 12 on a first side. The deformable wall 10 is bounded by a perimeter barrier 30 extending away from the first side 101 of the deformable wall 10 in a first direction. The deformable wall 10 further includes a pressure application point or hardware attachment 14 located substantially central to the second side 102 of the deformable wall 10. An extension 40 may be attached to the pressure application point or hardware attachment 14 to permit the apparatus 1 to be operated on bugs on ceilings or other hard to reach places or to distance the human operator from the bug upon which the device is being used.

It is an object of this invention to catch or trap bugs by enclosing or trapping the bug between a surface, such as a wall, floor, or ceiling, and the adhesive 12 on the deformable wall 10.

It is an object of the invention to catch or trap bugs using a deformable wall 10 having a first side 101 and a second side 102, the wall 10 having a first state and a second state, and wherein the wall 10 moves in a first direction to reach the second state.

It is an object of this invention to catch or trap bugs by contacting the bug with an adhesive 12 attached to a deformable wall 10 being in a deformed or flexed state, which thereafter is in a non deformed or non flexed state.

### BRIEF DESCRIPTION OF THE DRAWINGS OR PICTURES

FIG. 1 is a top perspective view of a first side of a first embodiment of the apparatus 1 with an extension 40;

FIG. 2 is a bottom view of a second side of the first embodiment of the apparatus 1 with the extension 40;

FIG. 3 is a side view of the first embodiment of the apparatus 1, showing a first state of the deformable wall;

FIG. 4 shows section A-A of FIG. 2, showing a second state of the deformable wall;

FIG. 5 is a perspective view of the first side of a first embodiment of the apparatus 1 showing bug capture;

FIG. 6 is an alternate embodiment of apparatus 1 showing a bump stop 50 located near the middle of deformable wall 10 and air hole 60 though perimeter barrier 30;

FIG. 7 shows a top view of apparatus showing pressure application point or hardware attachment 14 having one part fixed to deformable wall 10 and one part not fixed to deformable wall 10 and being flexible in relation to the fixed part;

FIG. 8 shows a side view of an alternate embodiment of apparatus 1 showing a bump stop 50 and the directional flexibility of one embodiment of pressure application point or hardware attachment 14;

FIG. 9 shows a perspective view of an embodiment of the best mode;

FIG. 10 is an exploded view of the elements featured with in detail A of FIG. 9;

FIG. 11 is a perspective view of an embodiment of the best mode;

FIG. 12 is a perspective view of the opposite side of the embodiment shown in FIG. 11;

FIG. 13 is a top view of the embodiment shown in FIG. 11;

FIG. 14 is a view of section A-A of FIG. 13;

FIG. 15 is a side view of Detail C of FIG. 14;

FIG. 16. is a perspective view of pole connector 42 of FIG. 10;

FIG. 17 is a side view of the pole connector 42 of FIG. 10;

FIG. 18 shows section A-A of FIG. 17;

FIG. 19 is a perspective view of locking tab 44;

FIG. 20 is the opposite perspective view of locking tab 44 showing an embodiment of slide-click coupling 48;

FIG. 21 is a side view of locking tab 44;

FIG. 22 is a top view of locking tab 44, showing an embodiment of slide-click coupling 48;

FIG. 23 shows a first state of the preferred embodiment; and,

FIG. 24 shows a second state of the preferred embodiment.

### DESCRIPTION OF THE EMBODIMENTS

The structure and structural assembly, overall operation and technical characteristics of the present invention will become apparent with the detailed description of a preferred embodiment and the illustration of the related drawings as follows.

The invention is defined by the full scope of the drawings, specification and claims. Now, with reference to specific embodiments, the bug catcher comprises a deformable wall 10 including an adhesive 12 on a first side 101 of the wall and bounded by a perimeter barrier 30 extending away from the wall in a first direction substantially orthogonal to the surface of the wall 10. The deformable wall 10 is manufactured to be capable of having a first state, characterized as an at-rest state, and a second state characterized as a flexed or a deformed state. As shown in FIG. 4, the second or deformed state is achieved when the wall 10 is deformed or flexed from the first state to the second state, and at least a portion of the wall 10 moves in the first direction.

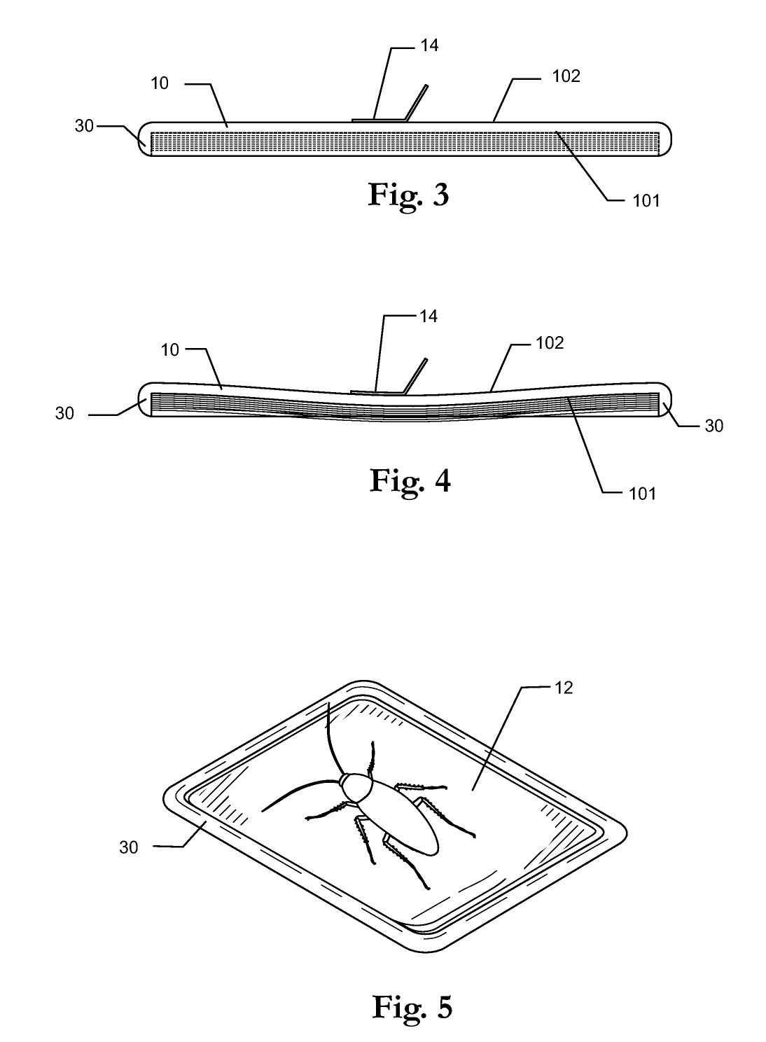

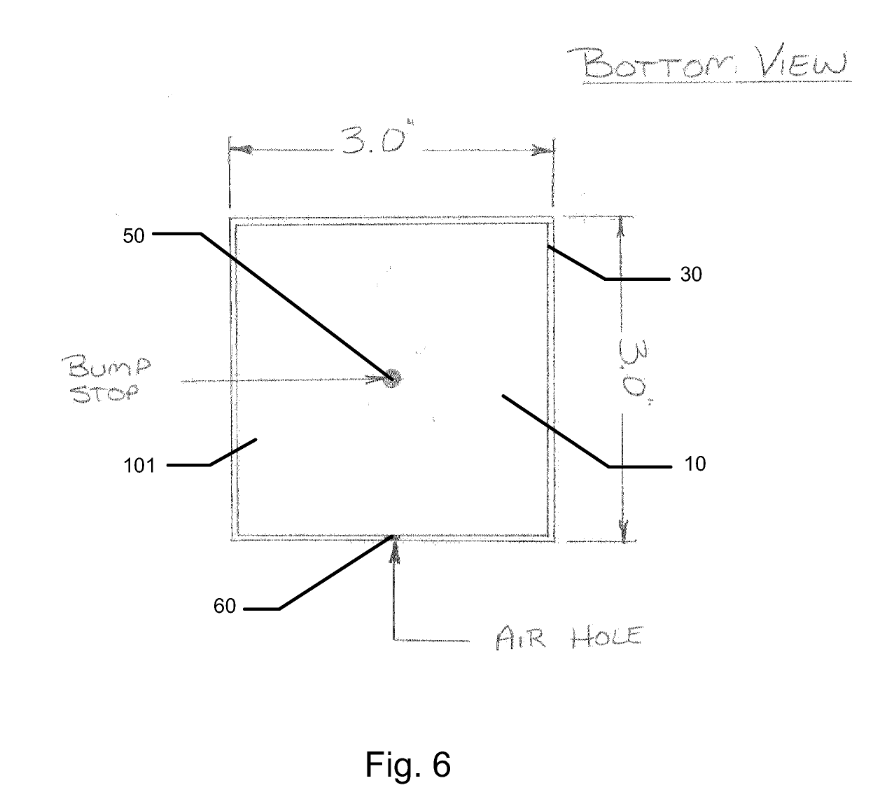

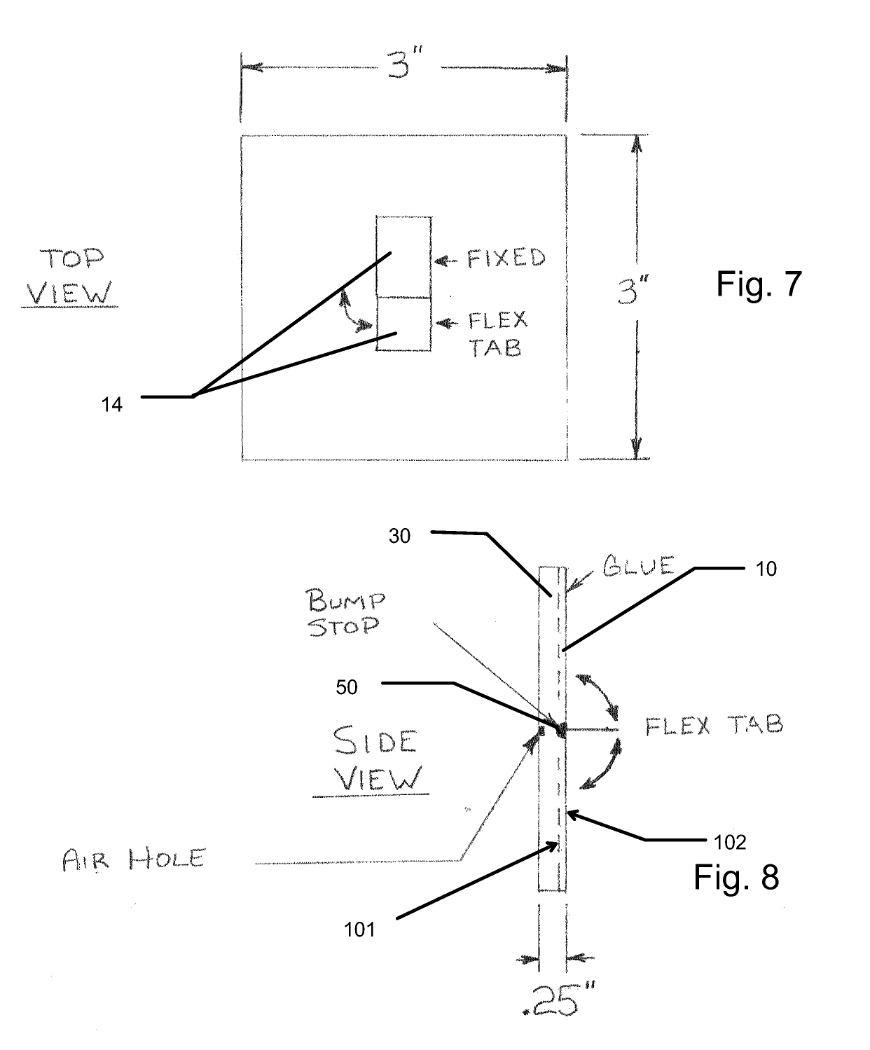

As more clearly illustrated in FIGS. 3 & 4, the deformable wall 10 comprises a relatively thin, sheet of material capable of deformation or flexation by the imposition of force or pressure applied from the direction of the second side 102 of the wall 10. The pressure applied to the second side 102 of the wall 10 would be that range of pressures or forces applied by an individual's fingers directly, or as translated through a hand-held extension rod. The deformable wall 10 is substantially flat, concave, or convex and comprised of a sheet or film of plastic, paper, wood, cardboard, metal, or some combination thereof. The preferred deformable wall 10 thickness is between about 0.005 and 0.5 inches but preferably less than about 0.025 inches.

The perimeter barrier 30 extends from the wall 10 in the first direction. The perimeter barrier 30 provides structural support for the apparatus 1 and operates as a standoff during bug capturing events. It follows that the structure and strength of the perimeter barrier is relatively rigid and inflexible relative to the flexibility, strength, or rigidity of the wall 10. The width or height of the perimeter barrier is between about 0.025 and 2.5 inches but preferably about 0.25 inches, or large enough to facilitate the capture and disposal of most household pests. The perimeter barrier 30 length is between about 1 inch and 15 inches, around and the cross sectional shape preferably selected from the group consisting of ovular, rectangular, triangular, or other closed shape. The perimeter barrier 30 comprises an even or uneven ridge or preferably has at least one vent. The perimeter barrier 30 can be constructed of plastic, paper, wood, cardboard, metal, or some combination thereof.

An alternate embodiment might include a protrusion (or bump stop) 50 is fixed on a first side 101 of the wall 10 and extends in a first direction away from the wall 10. The protrusion 50 comprises a shape selected from the group consisting of a brace, a ridge, an edge, a plug, cylinder or a bump. The protrusion 50 further prevents the entire deformable wall 10 from contacting the targeted surface and makes removal of the apparatus 1 from the surface even easier than without the protrusion 50.

Another alternative embodiment might include air hole 60. Air hole 60 can be located on perimeter barrier 30 to permit air to escape through air hole 60 from inside the perimeter barrier to outside the perimeter barrier during use. Air hole 60 may relieve any pressure buildup within the perimeter barrier 30 during use.

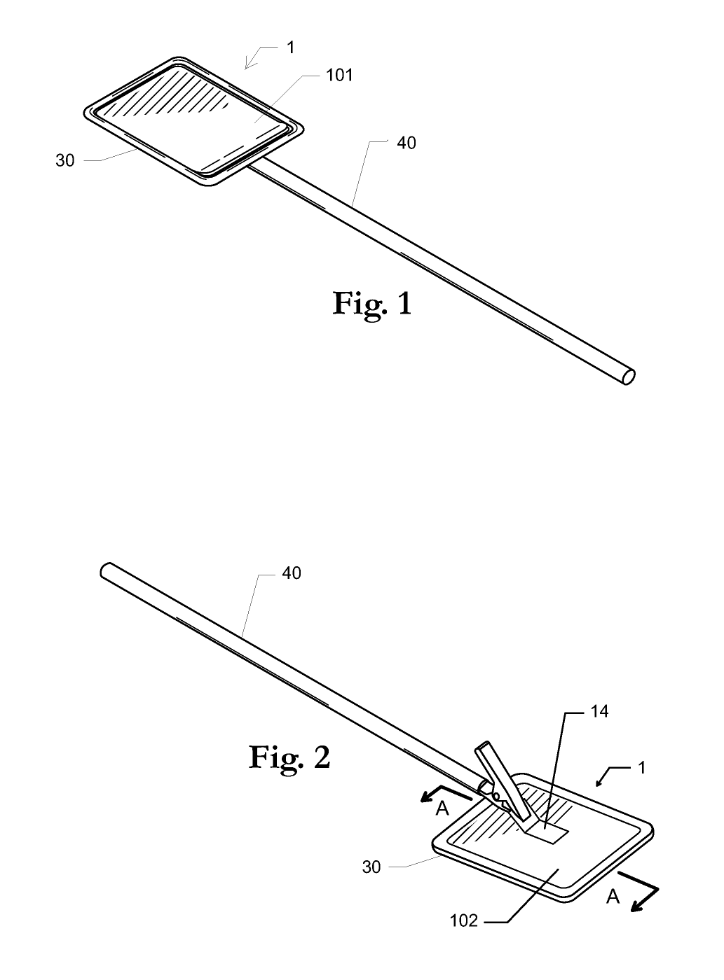

Pressure application hardware or attachment 14 is fixed or coupled substantially centrally on the second side 102 of the deformable wall 10 and consists of an structure selected from the group consisting of, a tab, a handle, a knob, a ridge, a hinge, or a button. As shown in FIG. 1, the hardware attachment 14 is optionally, fixedly or removably coupled, to an extension 40.

The apparatus 1 is used by positioning it over a bug and the household surface (e.g., without limitation, wall, ceiling, floor) to trap a bug. When the apparatus is positioned over a bug and over a household surface, the apparatus creates an enclosure comprised of at least three sides including, the deformable wall 10, the perimeter barrier 30, and the household surface. Further, when the apparatus 1 is brought down around the bug, the wall 10, perimeter barrier 30, and household surface the perimeter barrier 30 not only deters bug escape but prevents the entire first side 101 from touching the household surface when trapping a bug. The combination of deformable wall 10 and perimeter barrier 30 keep only a section of the first side 101 from touching the household surface. The benefit being that if the user misses the intended bug, the apparatus 1 can be removed from the household surface without a problem.

The deformable wall 10 is deformed or flexed as illustrated relative to the perimeter barrier 30 in a manner similar to the fabric or canvas movement of a trampoline. The deformable wall 10 therefore moves in a first direction substantially orthogonally or perpendicularly relative to the wall 10 surface, but characterized by differing amounts of deflection or movement relative to the position in an non flexed or non deformed first state. Deformable wall 10 deflection or movement will be greater at a central point than wall deflection or movement closer or adjacent to the perimeter barrier 30. The deformable wall 10 can be manufactured to various sizes and preferred embodiments have a square area of between about 2 square inches to 25 square inches. Further, the deformable wall 10 can be manufactured to have an ovular, rectangular, triangular, or other closed shape. An adhesive 12, either on a layer or an applied film or deposit on the first side 101 contacts the bug prevents the bug from escaping. Prior to usage, a removable film can be placed over the adhesive 12 and removed when the user is ready for bug capture.

After capturing a bug, it is preferred that the apparatus 1 be disposed of in the trash. In this way, the user never needs to get near the bug. At most, the user will only need to touch the hardware attachment 14. And if the user uses a mechanical device to hold the hardware attachment 14, such as the one shown in FIG. 2, the user will not even have to touch apparatus 1. The benefit of disposing apparatus 1 in the trash without having to put fingers near the bug side of apparatus 1 is particularly apparent when the bug at issue is a scorpion.

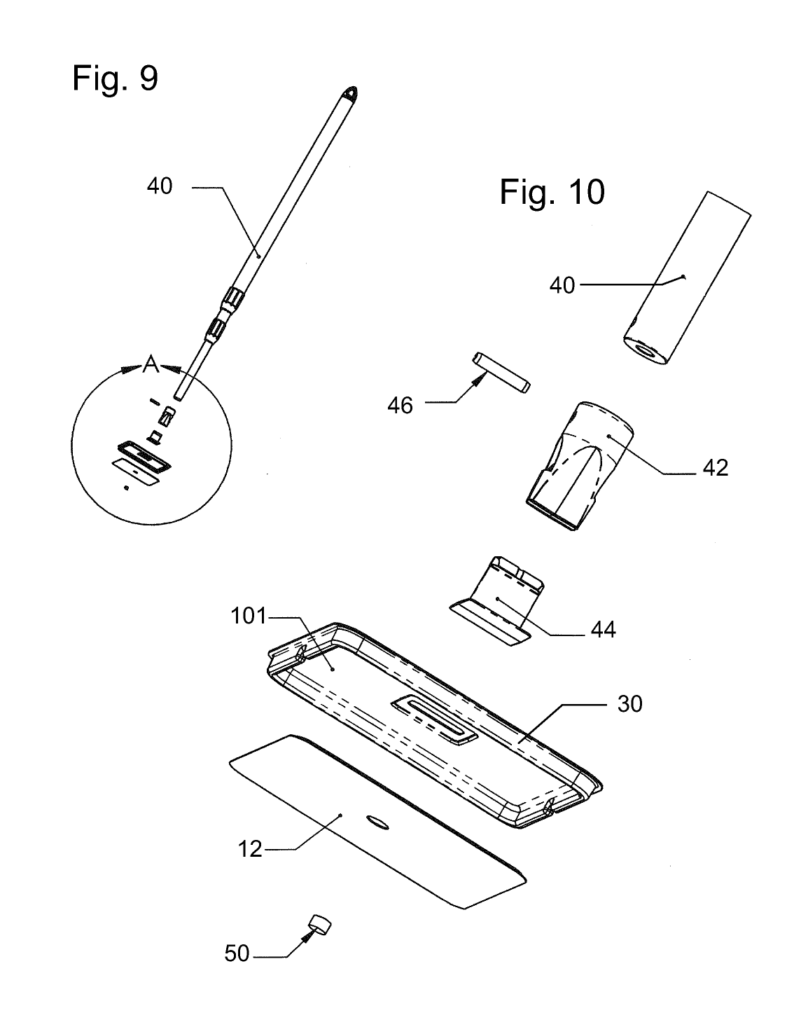

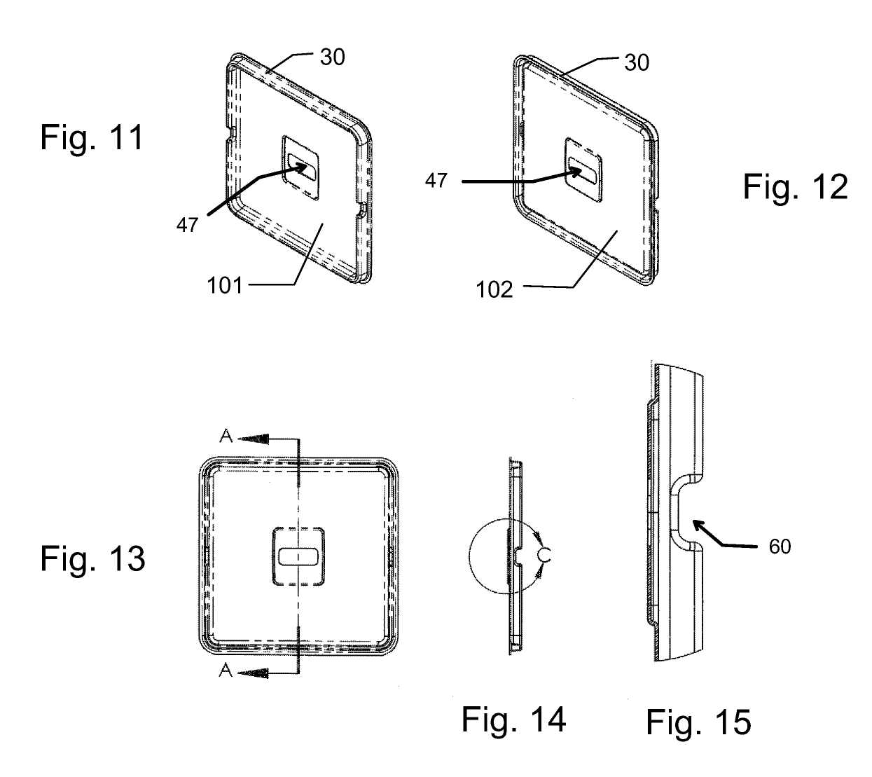

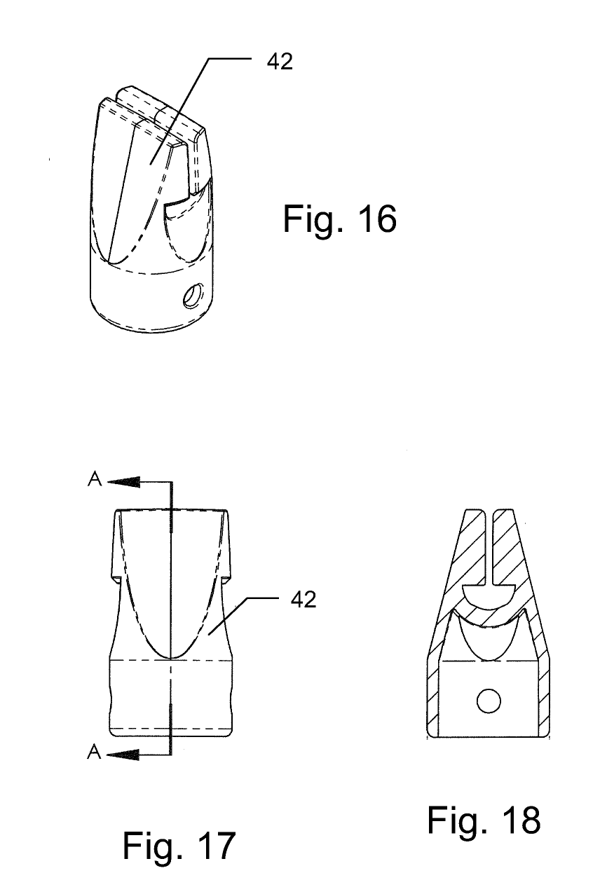

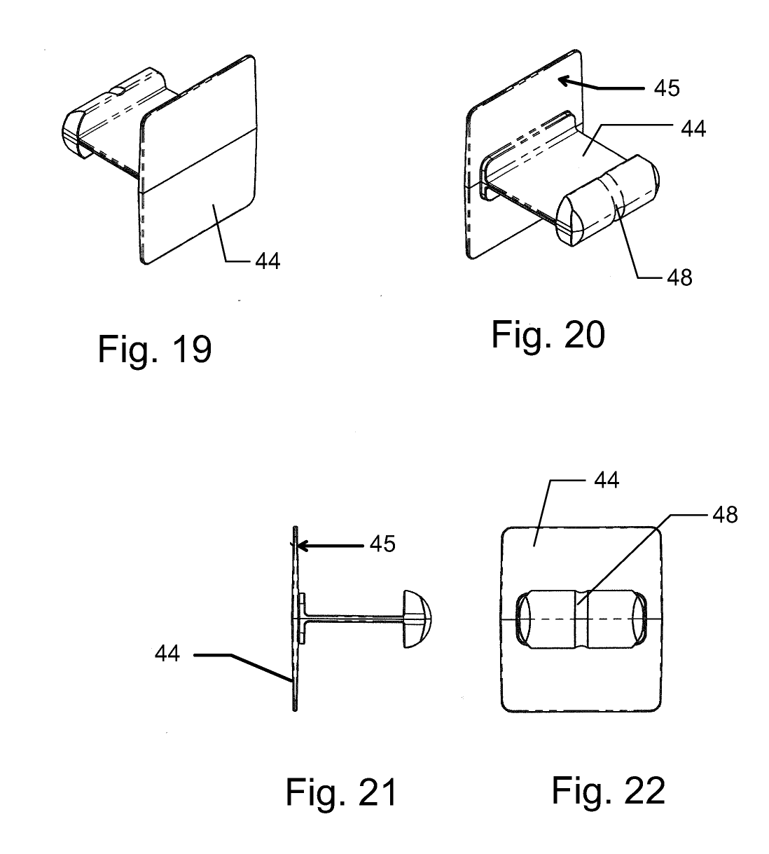

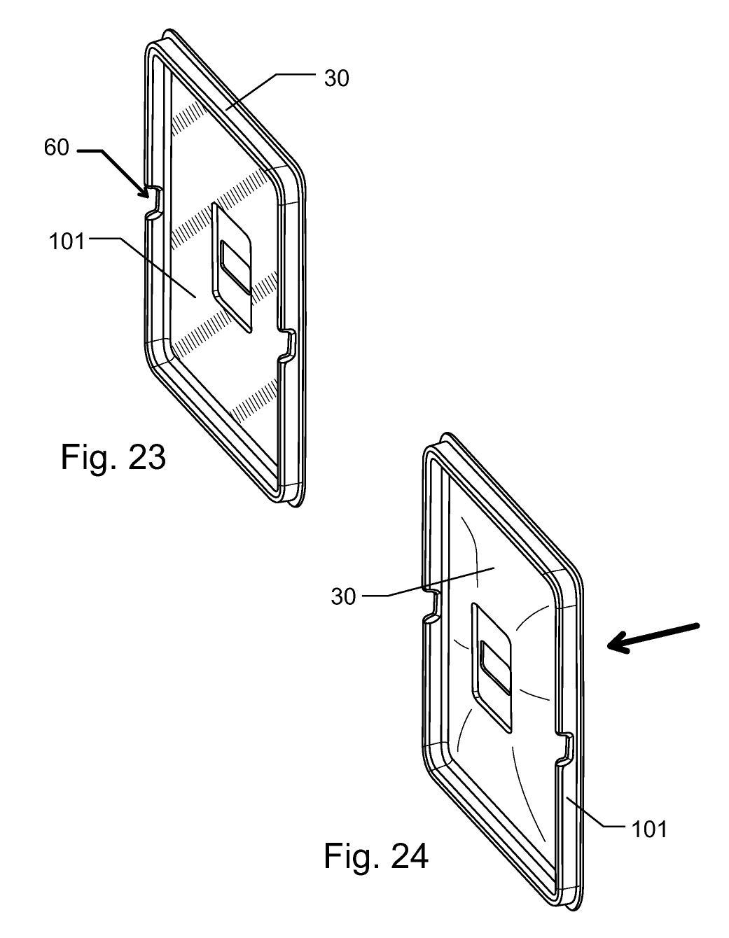

FIGS. 9-24 show the presently preferred embodiment of apparatus 1. FIG. 9 shows a three-piece extension 40. The exploded view of FIG. 10 shows a pole connector 42 for connecting to the end of the extension 40 by spring pin 46. Locking tab 44 slidably connects to the pole connector 42 and the user knows it is in position by way of slide-click coupling 48 and its corresponding mate on the pole tab 42. The preferred slide-click 48 and mate is just a male/female bump/channel to help the user center the locking tab 44 on the pole connector 42. Those in the art can device many other ways to achieve this centering mechanism.

Locking tab 44 is slidably disconnected from pole connector 42 in a similar, but reverse fashion. Locking tab 44 is preferably connected to the apparatus 1 by applying an adhesive material to top surface 45 and mating it with the first side 101 by sliding it though slot 47 of apparatus 1.

While the invention has been described by means of specific embodiments, numerous modifications and variations could be made thereto by those ordinarily skilled in the art without departing from the scope and spirit of the invention set forth in the claims.

1. An apparatus comprising:
a deformable wall having a first side and a second side and having adhesive on the first side; the deformable wall having a first state and a second state, wherein the first state is a resting state and the second state is reached by the application of pressure against the first or second side of the deformable wall;
a perimeter barrier extending from the wall in the first direction; and
a pressure application hardware attachment on the second side of the deformable wall.

2. The apparatus of claim 1 further comprising an air hole located on the apparatus to permit the flow of air from an interior space bounded by the first side and the perimeter through the apparatus to other side of the apparatus.

3. The apparatus of claim 1 further comprising an extension that temporarily connects the pressure application hardware attachment.

4. The apparatus of claim 3, wherein the temporary connection comprises a locking tab connected to the apparatus and a pole connector connected to the extension, the locking tab being slidably connectable to the pole connector.

5. The apparatus of claim 4, the locking tab and pole connector having a matable slide-click coupling for centering the locking tab within the pole connector.
